(19) United States
(12) Patent Application Publication
(10) Pub. No.: US 2022/0414588 A1
(43) Pub. Date: Dec. 29, 2022

(54) TRANSACTION MANAGEMENT APPARATUS, TRANSACTION MANAGEMENT METHOD, AND NON-TRANSITORY COMPUTER-READABLE STORAGE MEDIUM

(71) Applicant: NEC Corporation, Minato-ku, Tokyo (JP)

(72) Inventor: Koji MIZUGUCHI, Tokyo (JP)

(73) Assignee: NEC Corporation, Minato-ku, Tokyo (JP)

(21) Appl. No.: 17/776,710

(22) PCT Filed: Nov. 13, 2020
(86) PCT No.: PCT/JP2020/042408

§ 371 Date: May 13, 2022

(30) Foreign Application Priority Data
Nov. 18, 2019 (JP) 2019-207688

(51) Int. Cl. G06Q 10/08

(52) U.S. Cl. CPC G06Q 10/087; G06Q 10/0834

(57) ABSTRACT

A transaction management apparatus (100) includes an acquisition unit (102) that acquires, for a same piece of merchandise, a supply condition of each of a plurality of suppliers, a sales condition of each of a plurality of customers, and a transport condition of each of a plurality of transport means; and a determination unit (104) that determines, for each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers is optimized by using a plurality of the acquired supply conditions, a plurality of the acquired sales conditions, and a plurality of the acquired transport conditions.

### TECHNICAL FIELD

The present invention relates to a transaction management apparatus, a transaction management method, and a program, and particularly relates to a transaction management apparatus, a transaction management method, and a program that integrally manage a plurality of transactions.

### BACKGROUND ART

Patent Document 1 describes an energy transaction management system that manages a transaction, based on a transaction contract concluded when energy procured from a consumer is wholesaled. In the system, a facility operation management apparatus generates an operation plan of a load facility of a consumer. The energy transaction management apparatus derives a difference between a predicted value of an energy consumption amount based on an operation plan, and a reference value of a procurement amount, and sets the difference as an amount of energy to be procured. Further, the energy transaction management apparatus sets, as a wholesale energy amount, a difference between the predicted value and a reference value of a wholesale amount. The energy transaction management apparatus computes a cost (an adjustment amount and a wholesale amount) associated with each of an amount of energy to be procured and a whole-saleable amount of energy, derives the difference as profit and loss, and a transaction plan is generated and output by associating a wholesale transaction contract, an operation plan, and a start time of the operation plan when the profit and loss is equal to or more than a target value.

A trading company and the like in which fuel supplied from each country is sold to an electricity utility such as a power company perform matching regarding combination of transactions between a plurality of suppliers and a plurality of customers. Since fuel is transported from a supplier to a customer by a transport means such as a ship, arrangement and adjustment of the transport means are also performed at the same time. A transaction condition is defined in advance by a contract between a supplier and a customer, and it is necessary to establish a transaction within a range of the transaction condition.

### RELATED DOCUMENT

### Patent Document

[Patent Document 1] Japanese Patent Application Publication No. 2015-222472

### SUMMARY OF THE INVENTION

### Technical Problem

In a case where a large number of transaction parties are present, a trader has to make a plan regarding combination of transactions, and repeat revision of a transaction condition, while negotiating with the transaction parties for relaxation of conditions.

In this case, a trader makes efforts to raise a profit from each transaction, however, a result may be different due to a difference in experience and ability among individual traders. Further, it is not necessarily always a case that raising a profit in individual transactions leads to raising a total profit of the entirety of transactions. For example, even when a certain degree of loss occurs in some transaction, when a profit that exceeds the loss is gained in another transaction, the profit may be raised as a whole. In view of the above, it is necessary to efficiently manage the entirety of merchandise transactions between a plurality of suppliers and a plurality of customers.

The present invention has been made in view of the above-described problem, and an object of the present invention is to provide a technique for efficiently managing the entirety of merchandise transactions between a plurality of suppliers and a plurality of customers.

### Solution to Problem

In each aspect of the present invention, to solve the above-described problem, the following configuration is adopted in each aspect.

A first aspect relates to a transaction management apparatus.

The transaction management apparatus according to the first aspect incudes:

an acquisition unit that acquires, for a same piece of merchandise, a supply condition of each of a plurality of suppliers, a sales condition of each of a plurality of customers, and a transport condition of each of a plurality of transport means; and

a determination unit that optimizes and determines, for the each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

A second aspect relates to a transaction management method to be executed by at least one computer.

The transaction management method according to the second aspect includes:

by a transaction management apparatus,

acquiring, for a same piece of merchandise, a supply condition of each of a plurality of suppliers, a sales condition of each of a plurality of customers, and a transport condition of each of a plurality of transport means; and

optimizing and determining, for the each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

Note that, another aspect of the present invention may be directed to a program causing at least one computer to execute the above-described method of the second aspect, or may be directed to a computer-readable storage medium storing a program as described above. The storage medium includes a non-transitory tangible medium.

The computer program includes a computer program code causing a computer to implement the transaction management method on a transaction management apparatus when being executed by the computer.

Note that, any combination of the above-described constituent elements, and a configuration that an expression of the present invention is converted among a method, an apparatus, a system, a storage medium, a computer program, and the like are also valid as an embodiment according to the present invention.

Further, each kind of constituent element according to the present invention does not necessarily have to be an individually independent element, and may be a configuration in which a plurality of constituent elements are configured as one member, a configuration in which one constituent element is constituted of a plurality of members, a configuration in which a certain constituent element is a part of another constituent element, a configuration in which a part of a certain constituent element and a part of another constituent element overlap, and the like.

Further, a plurality of procedures are described in order in the method and the computer program according to the present invention, however, the order of the description does not limit the order in which the plurality of procedures are executed. Therefore, when the method and the computer program according to the present invention are implemented, it is possible to change the order of the plurality of procedures, as far as the change does not adversely affect a content of the procedures.

Furthermore, a plurality of procedures of the method and the computer program according to the present invention are not limited to a configuration in which the procedures are executed at an individually different timing. Therefore, another procedure may be generated during execution of a certain procedure, a part or all of an execution timing of a certain procedure and an execution timing of another procedure may overlap, or the like.

### Advantageous Effects of Invention

According to each aspect as described above, it is possible to provide a technique for efficiently managing the entirety of merchandise transactions between a plurality of suppliers and a plurality of customers.

### BRIEF DESCRIPTION OF THE DRAWINGS

FIG. 1 is a diagram illustrating an overview of a transaction management system according to an example embodiment of the present invention.

FIG. 2 is a functional block diagram illustrating a logical configuration example of a transaction management apparatus according to the example embodiment of the present invention.

FIG. 3 is a block diagram illustrating a hardware configuration of a computer that achieves the transaction management apparatus illustrated in FIG. 2.

FIG. 4 is a flowchart illustrating an operation example of the transaction management apparatus according to the present example embodiment.

FIG. 5 is a diagram each illustrating an example of a data structure of a transaction condition.

FIG. 6 is a diagram illustrating an example of a data structure of a transport condition.

FIG. 7 is a functional block diagram illustrating a logical configuration example of the transaction management apparatus according to the example embodiment of the present invention.

FIG. 8 is a diagram illustrating an example of a screen for an optimization result.

FIG. 9 is a functional block diagram illustrating a logical configuration example of the transaction management apparatus according to the example embodiment of the present invention.

FIG. 10 is a flowchart illustrating an operation example of the transaction management apparatus according to the present example embodiment.

FIG. 11 is a functional block diagram illustrating a logical configuration example of the transaction management apparatus according to the example embodiment of the present invention.

FIG. 12 is a diagram illustrating one example of a screen for a relaxation simulation result.

FIG. 13 is a diagram illustrating one example of a screen for a ship navigation route result.

FIG. 14 is a diagram illustrating one example of a screen for a ship schedule.

### DESCRIPTION OF EMBODIMENTS

Hereinafter, example embodiments according to the present invention are described with reference to the drawings. Note that, in all the drawings, a similar constituent element is indicated by a similar reference sign, and description thereof is omitted as necessary. In the following each diagram, a configuration of a portion that is not relevant to the essence of the present invention is omitted, and is not illustrated.

In the example embodiments, “acquisition” includes at least either one of acquisition of data or information stored in another apparatus or a storage medium by an own apparatus (active acquisition), and input of data or information to be output from another apparatus to an own apparatus (passive acquisition). Examples of active acquisition include requesting or inquiring another apparatus and receiving a reply, accessing to another apparatus or a storage medium and reading, and the like. Further, examples of passive acquisition include receiving information to be distributed (or transmitted, push-notified, or the like), and the like. Further, “acquisition” may include acquisition by selecting from among received data or information, or receiving by selecting from among distributed data or information.

### First Example Embodiment

### Overview of System

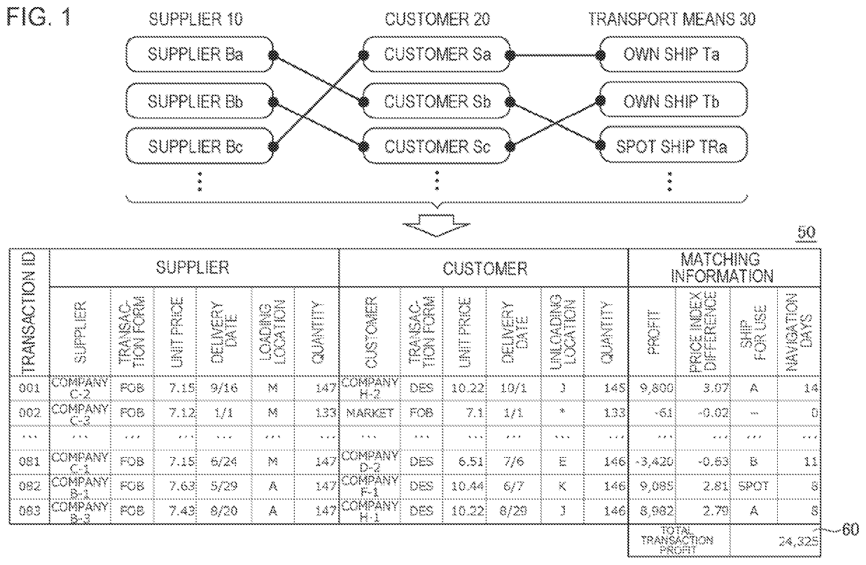

FIG. 1 is a diagram illustrating an overview of a transaction management system according to an example embodiment of the present invention.

A trader establishes a transaction by matching a plurality of customers 20 (in FIG. 1, three customers Sa, Sb, and Sc are illustrated, but the number of customers is not limited to three) who buy a piece of certain merchandise from each of a plurality of suppliers 10 (in FIG. 1, three suppliers Ba, Bb, and Bc are illustrated, but the number of suppliers is not limited to three), and sell. Further, the trader determines a transaction by further matching a transport means 30 (in FIG. 1, three ships, namely, an own ship Ta, an own ship Tb, and a spot ship TRa are illustrated, but the number of transport means is not limited to three) that transports the merchandise from the supplier 10 to the customer 20.

A piece of merchandise for transaction includes, for example, fuel such as crude oil, liquefied natural gas (LNG), liquefied petroleum gas (LPG), a petroleum product, and coal. Other examples include chemicals, iron ore, nonferrous metal, grain, and the like.

The transport means 30 includes a ship, an airplane, a vehicle, a train, and the like.

A transport plan is made for one year collectively, and is determined after having been updated several times. Note that, a period for a transport plan is not limited to one year, other period may be applied, and a period such as several months or several years, for example three months or three years may be available.

Therefore, the number of transaction parties becomes an enormous number. In view of this, negotiations are performed by distributing responsibilities of a plurality of suppliers 10 and a plurality of customers 20 being transaction parties to each trader, for example, for each region of a transaction party. A department manager manages the entirety of transactions by receiving and putting together a report from each person in charge. However, in a case of this method, each trader makes efforts to raise a profit from each transaction, but a result may differ due to a difference in experience and ability among individual traders. Further, it is not necessarily always a case that raising profits in individual transactions leads to raising a total profit of the entirety of transactions. For example, even when a certain degree of loss occurs in some transaction, when a profit that exceeds the loss is gained in another transaction, the profit may be raised as a whole.

Further, in a case where an operation status of a ship or an airplane changes due to weather conditions, or a ship or an airplane is cancelled, a change may be forced, which imposes a heavy burden on a trader.

In the example in FIG. 1, a matching result 50 includes a transaction content of each transaction, a profit and a price difference, and a total transaction profit 60 of all transactions, when the supplier 10, the customer 20, and the transport means 30 are combined. A transaction content of the supplier 10 includes a name (identification information), a transaction form (e.g., free on board (FOB), or delivered ex ship (DES)), a price of a piece of merchandise (such as a unit price), a delivery date, a loading location, and a quantity of merchandise. A transaction content of the customer 20 includes a name (identification information), a transaction form (e.g., FOB or DES), a price of a piece of merchandise (such as a unit price), a delivery date, an unloading location, and a quantity of merchandise. Further, a transaction content of the transport means 30 includes a ship for use, navigation days, and the like. Note that, a transaction form of the supplier 10 and the customer 20 differs depending on a piece of target merchandise, and for example, in a case of LPG, cost and freight (CFR), cost insurance and freight (CIF), and the like may be handled, in addition to FOB and DES.

In this example, for example, regarding transactions with transaction IDs 002 and 081, the profits becomes minus. However, since the total transaction profit 60 of the entirety of the transactions becomes plus, there is no problem.

A transaction management system according to the present invention enables to efficiently raise a profit by managing transactions as a whole.

### Functional Configuration Example

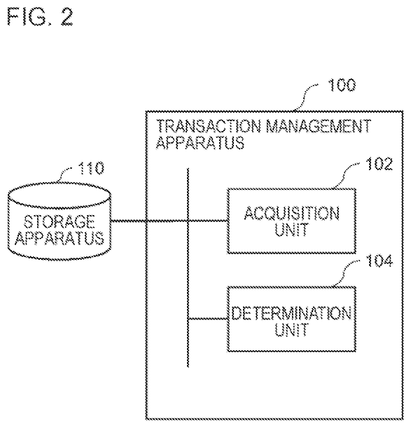

FIG. 2 is a functional block diagram illustrating a logical configuration example of a transaction management apparatus 100 according to the example embodiment of the present invention.

The transaction management apparatus 100 includes an acquisition unit 102 and a determination unit 104.

The acquisition unit 102 acquires, for a same piece of merchandise, a supply condition of each of a plurality of the suppliers 10, a sales condition of each of a plurality of the customers 20, and a transport condition of each of a plurality of the transport means 30.

The determination unit 104 optimizes and determines a transaction content for each transaction in such a way that a total profit from a plurality of transactions of the merchandise between a plurality of the suppliers 10 and a plurality of the customers 20 increases by using a plurality of the acquired supply conditions, a plurality of the acquired sales conditions, and a plurality of the acquired transport conditions.

The transaction content includes at least a supply quantity of the supplier 10, a loading quantity of the transport means 30 for each loading location, and an unloading quantity of the transport means 30 for each unloading location.

A supply condition 202 and a sales condition 204 are transaction conditions that have been contracted in advance with each transaction party (the supplier 10 or the customer 20), and the determination unit 104 determines a transaction content of each transaction in such a way that the transaction content lies within a range of the transaction condition.

A same piece of merchandise is, for example, a product whose transaction party is the same, and as far as the merchandise can be handled together by one time transaction, the merchandise may include a product whose component or quality is different, as exemplified by LNG and the like, or a product whose type is different such as propane and butane, as exemplified by LPG and the like.

Further, the determination unit 104 determines a supply quantity of the supplier 10 in such a way that a profit margin between a price for the customer 20 and a price for the supplier 10 increases for each transaction. Thus, a transaction content can be optimized

The determination unit 104 maximizes a supply quantity, when a profit margin is a plus margin, and minimizes a supply quantity, when a profit margin is a minus margin.

Optimization is achieved by mathematical optimization processing in the determination unit 104. Further, the determination unit 104 may perform optimization processing by machine learning. Furthermore, optimization processing can be performed for a purpose other than increasing the total transaction profit 60 described above. For example, optimization may be performed in such a way as to strictly follow a delivery date. For example, a transaction content having a margin may be generated in such a way that a robust plan is made even against external disturbance such as deterioration of weather. For example, the determination unit 104 selects a most economical navigation velocity within a range set in advance by an operator, for example, within a range from 13 to 18.5 knots, by strictly following a delivery date, and taking into consideration fuel consumption, a market fluctuation due to a difference in arrival date, and the like. Actually, a ship can navigate at a navigation velocity of 18.5 knots or more, but a margin is secured by setting the navigation velocity to a value less than 18.5. Thus, it is possible to avoid a delivery delay risk due to a bad weather, a waiting time until start of cargo handling, a traffic jam at a canal, and the like.

The transaction management apparatus 100 further includes a storage apparatus 110. The storage apparatus 110 may be installed inside the transaction management apparatus 100, or may be installed outside the transaction management apparatus 100. In other words, the storage apparatus 110 may be hardware integrally formed with the transaction management apparatus 100, or may be hardware independent of the transaction management apparatus 100. The transaction management apparatus 100 and the storage apparatus 110 may be connected by a communication network.

The storage apparatus 110 stores the supply condition 202 of a plurality of the suppliers 10, the sales condition 204 of a plurality of the customers 20, and a transport condition 206 of a plurality of the transport means 30 acquired by the acquisition unit 102. The storage apparatus 110 also stores a transaction content of each transaction matched by the determination unit 104, and information such as a total profit. The transaction content and the total profit information may be stored, for example, in a text data file (e.g., JavaScript (registered trademark) object notation (JSON) format), a concurrent versions system (CVS), a table format data file, or the like. Alternatively, the transaction content and the total profit information may be stored in a database format.

### Hardware Configuration Example

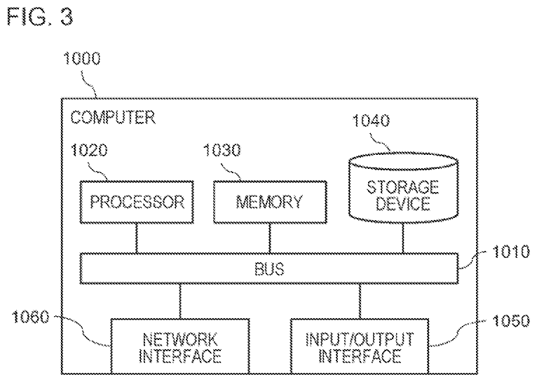

FIG. 3 is a block diagram illustrating a hardware configuration of a computer 1000 that achieves the transaction management apparatus 100 illustrated in FIG. 2. The computer 1000 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module that achieves each function of the computer 1000. The processor 1020 achieves each function associated with each program module by reading each of these program modules in the memory 1030 and executing each of these program modules. Further, the storage device 1040 may also store each piece of data of the storage apparatus 110.

The program module may be stored in a storing medium. A storing medium storing the program module may include a medium usable by the non-transitory tangible computer 1000, and a program code readable by the computer 1000 (processor 1020) may be embedded in the medium.

The input/output interface 1050 is an interface for connecting the computer 1000 and various types of input/output equipment each other.

The network interface 1060 is an interface for connecting the computer 1000 to a communication network. The communication network is, for example, a local area network (LAN) or a wide area network (WAN). A method of connecting the network interface 1060 to a communication network may be wireless connection or may be wired connection.

The computer 1000 is connected to necessary equipment (e.g., a display, a keyboard, a mouse, a printer, and the like) via the input/output interface 1050 or the network interface 1060.

The computer 1000 that achieves the transaction management apparatus 100 is, for example, a personal computer, a smartphone, a tablet terminal, or the like. For example, the transaction management apparatus 100 is achieved by installing and activating an application program for achieving the transaction management apparatus 100 on the computer 1000.

As another example, the computer 1000 may be a webserver, and a user may activate a browser by a user terminal such as a personal computer, a smartphone, or a tablet terminal, and use a function of the transaction management apparatus 100 by accessing to a webpage that provides a transaction management service of the transaction management apparatus 100 via a network such as the Internet.

As yet another example, the computer 1000 may be a server apparatus of a system such as a software as a service (SaaS) that provides a transaction management service of the transaction management apparatus 100. A user may access to the server apparatus from a user terminal such as a personal computer, a smartphone, or a tablet terminal via a network such as the Internet, and the transaction management apparatus 100 may be achieved by a program operating on the server apparatus.

### Operation Example

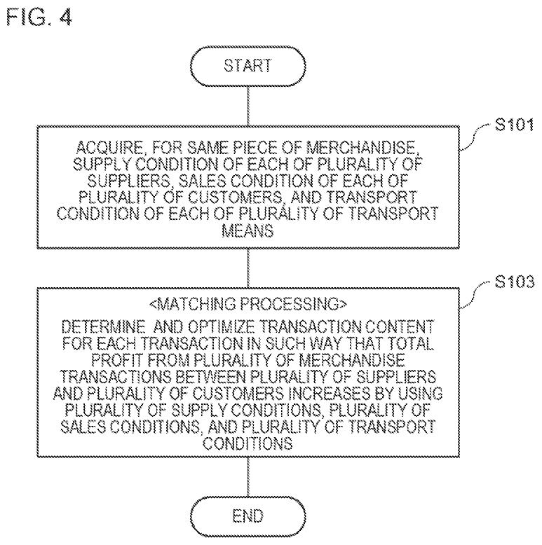

FIG. 4 is a flowchart illustrating an operation example of the transaction management apparatus 100 according to the present example embodiment.

First, the acquisition unit 102 acquires, for a same piece of merchandise, a supply condition of each of a plurality of the suppliers 10, a sales condition of each of a plurality of the customers 20, and a transport condition of each of a plurality of the transport means 30 (step S101).

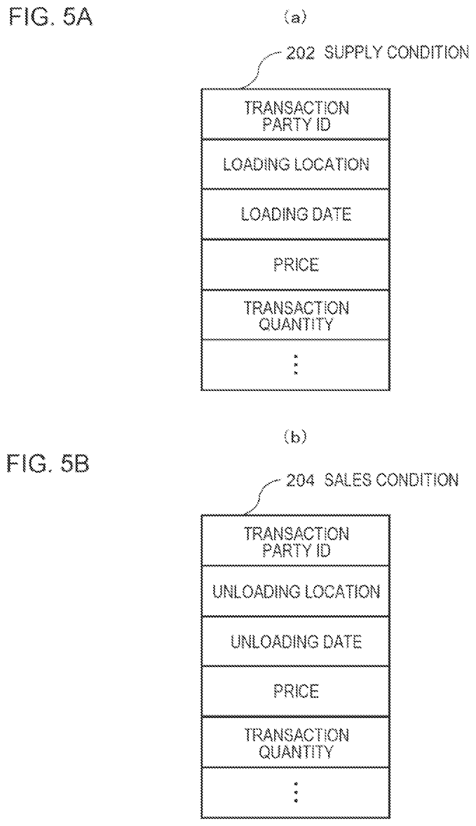

FIG. 5 is a diagram each illustrating an example of a data structure of a transaction condition. FIG. 5A illustrates the supply condition 202, and FIG. 5B illustrates the sales condition 204. The supply condition 202 includes at least a transaction party ID, a loading location (e.g., a loading port), a loading date, a price of a piece of merchandise, and a transaction quantity of the merchandise. The sale condition 204 includes at least a transaction party ID, an unloading location (e.g., a loading port), an unloading date, a price of a piece of merchandise, and a transaction quantity of the merchandise.

The transaction party ID includes information for identifying the supplier 10 and the customer 20, and information for identifying individuals. The loading port and the unloading port are each piece of information indicating specification, constraint, or the like of a port where merchandise for transaction is loaded, and a port where the merchandise is unloaded, and include at least either one of a name of a port, and identification information that identifies a port. The loading date and the unloading date indicate a period of time (at least either one of a start day and an end day) when the merchandise is loaded or unloaded.

The price indicates a range (at least either one of an upper limit and a lower limit) of a supply unit price or a sales unit price of a piece of merchandise, and may be indicated by a price formula (including a price index). The transaction quantity indicates a range (at least either one of an upper limit and a lower limit) of a quantity of merchandise. A unit of a transaction quantity differs depending on a kind of merchandise, and includes a range (at least either one of an upper limit and a lower limit) of one of a volume, a weight, a calorie, and the like. In addition to the above, a quality condition of merchandise (such as information indicating a ranking, or information indicating purity) may be included.

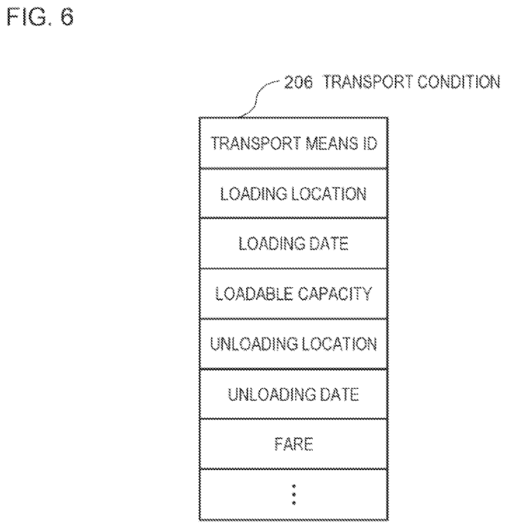

FIG. 6 is a diagram illustrating an example of a data structure of the transport condition 206. The transport condition 206 includes at least a transport means ID, a loading location (e.g., a loading port), a loading date, a loadable capacity, an unloading location (e.g., a loading port), an unloading date, and a fare. The transport means ID is information for identifying a transport means (e.g., an individual ship or an individual airplane), and may include information (e.g., information that discriminates between a ship and an airplane, or information that discriminates between an own ship and a spot ship) indicating a kind of a transport means. The own ship is a ship owned by a trading company or the like, or a ship for which a charter contract is made with a shipowner for a fixed period of time. The spot ship is a ship owned by another company, and is temporarily used by paying a rental fee.

The loading port and the unloading port include information indicating specification, constraint, or the like of a port where the transport means performs loading and unloading. The loading date and the unloading date indicate a period of time (at least either of a start day and an end day) when the transport means loads merchandise, and a period of time when the transport means unloads the merchandise. The loadable capacity includes at least either of a tank capacity and a tank loadable capacity of the transport means. The fare is a daily cost such as a fuel cost and a labor cost in a case of an own ship, and is a cost such as a rental fee in a case of a spot ship.

Referring back to FIG. 4, the determination unit 104 determines a transaction content for each transaction in such a way that a total profit from a plurality of merchandise transactions between a plurality of the suppliers 10 and a plurality of the customers 20 is optimized by using the acquired supply conditions 202 of a plurality of the suppliers 10, the acquired sales conditions 204 of a plurality of the customers 20, and the acquired transport conditions 206 of a plurality of the transport means 30 (step S103).

As illustrated in FIG. 1, the determination unit 104 performs optimization in such a way as to raise the total transaction profit 60 within a range of each condition, and determines a transaction content by combining the supplier 10, the customer 20, and the transport means 30 for matching.

In the transaction management apparatus 100 according to the present example embodiment, the acquisition unit 102 acquires the supply conditions 202 of a plurality of the suppliers 10, the sales conditions 204 of a plurality of the customers 20, and the transport conditions 206 of a plurality of the transport means 30, and the determination unit 104 determines a transaction content by matching in such a way that the total profit increases.

Thus, it is possible to efficiently generate a combination in which a total profit of the entirety of transactions can be increased as much as possible within a range of a transaction condition defined in a contract with each transaction party.

### Second Example Embodiment

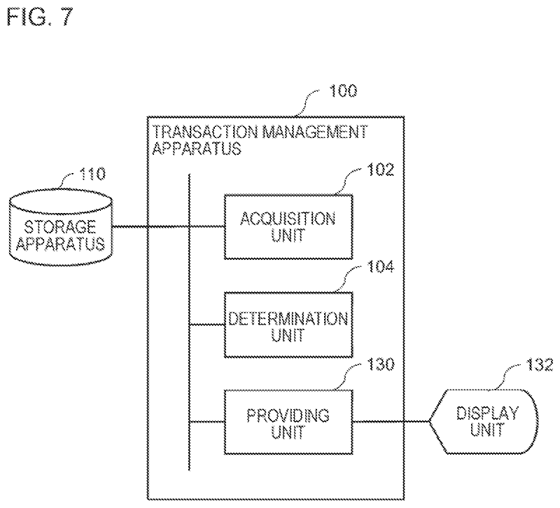

FIG. 7 is a functional block diagram illustrating a logical configuration example of a transaction management apparatus 100 according to an example embodiment of the present invention. The transaction management apparatus 100 according to the present example embodiment is the same as the transaction management apparatus 100 according to the above-described example embodiment in FIG. 2 except for a point that the transaction management apparatus 100 includes a configuration that provides a transaction content. A configuration of the transaction management apparatus 100 according to the present example embodiment may be combined with a transaction management apparatus 100 according to another example embodiment as far as contradiction does not occur.

### Functional Configuration Example

The transaction management apparatus 100 includes an acquisition unit 102, and a determination unit 104 similarly to the transaction management apparatus 100 in FIG. 2, and further includes a providing unit 130.

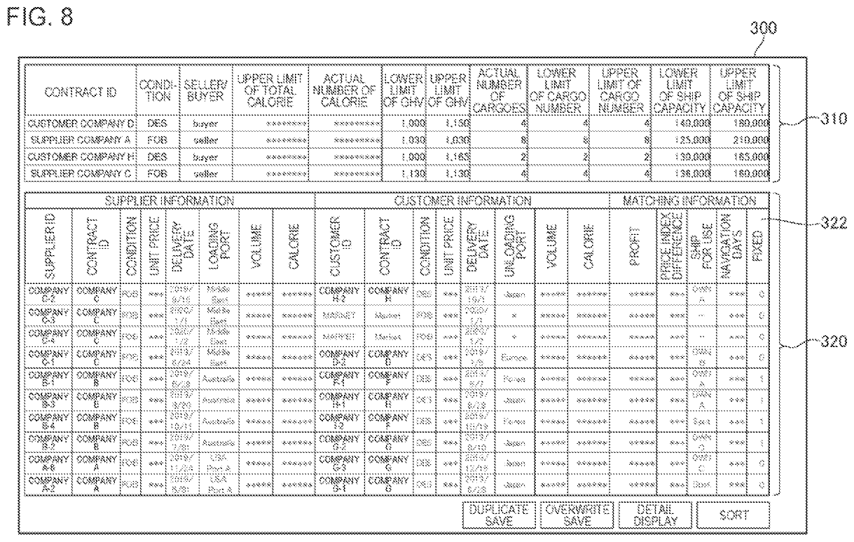

The providing unit 130 provides a transaction content determined by the determination unit 104. In an example in FIG. 7, the providing unit 130 displays, on a display unit 132, a screen for an optimization result 300 in FIG. 8. Further, the providing unit 130 may print and output, on a printer, a matching result 50 including at least a transaction content, or output and store the matching result 50 in a storage apparatus 110 as a data file.

The display unit 132 is a display apparatus of the transaction management apparatus 100, and is a liquid crystal display, an organic EL display, or a cathode ray tube (CRT). The display unit 132 may be a touch panel. The display unit 132 may be hardware integrally formed with the transaction management apparatus 100, or may be hardware independent of the transaction management apparatus 100.

FIG. 8 is a diagram illustrating an example of the screen for an optimization result 300.

The screen for an optimization result 300 includes contract information 310, and matching details 320. The contract information 310 includes a supply condition 202 and a sales condition 204. Note that, details of the screen for an optimization result 300 are described in an example embodiment to be described later.

According to the configuration, an advantageous effect similar to that of the above-described example embodiment is provided, and the providing unit 130 can provide a user (herein, a trader, or a manager of the trader) with a transaction content determined by the determination unit 104. Since the screen for an optimization result 300 includes, in a list, a matching result on the entirety of a plurality of suppliers 10, a plurality of customers 20, and a plurality of transport means 30, it is possible to manage the entirety of transactions, instead of an individual transaction content for each area or the like.

### Third Example Embodiment

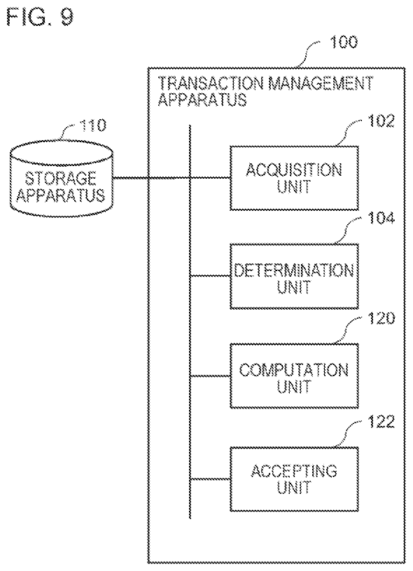

FIG. 9 is a functional block diagram illustrating a logical configuration example of a transaction management apparatus 100 according to an example embodiment of the present invention. In the above-described example embodiment, a transaction content is optimized based on a transaction condition defined in a contract with a transaction party. However, it is also possible to relax a transaction condition by negotiation with a transaction party. In view of the above, the transaction management apparatus 100 according to the present example embodiment has a configuration in which a case where a transaction condition is relaxed is simulated, and optimization is performed based on a transaction condition that is actually relaxed as a result of negotiation with a transaction party. A configuration of the transaction management apparatus 100 according to the present example embodiment may be combined with a transaction management apparatus 100 according to another example embodiment as far as contradiction does not occur.

### Functional Configuration Example

The transaction management apparatus 100 includes an acquisition unit 102, and a determination unit 104 similarly to the transaction management apparatus 100 in FIG. 2, and further includes a computation unit 120 and an accepting unit 122.

The computation unit 120 computes a total transaction profit 60 of a plurality of transactions between a plurality of customers 20 and a plurality of suppliers 10, based on a plurality of transaction contents determined by the determination unit 104.

The accepting unit 122 accepts an input by an operator indicating an alteration of a transaction condition for relaxing at least either one of transaction conditions being a supply condition 202 and a sales condition 204.

When an alteration of a transaction condition is accepted by the accepting unit 122, the determination unit 104 alters a determined transaction content by using the altered transaction condition.

The computation unit 120 computes a total transaction profit 60 after alteration, based on the altered transaction content.

Further, the computation unit 120 may compute a change amount between a total transaction profit 60 before alteration and a total transaction profit 60 after alteration. Furthermore, the computation unit 120 also computes a profit for each transaction before alteration and after alteration.

Herein, relaxation of a condition means shifting or altering a condition, or expanding a range of a condition, regarding a portion in which a transaction condition of each of the supplier 10, the customer 20, and a transport means 30 does not meet in matching. Further, relaxation of a condition also includes shifting or altering a part of a transaction condition, or expanding a range of a part of a transaction condition in such a way that a profit on a trading company side increases.

Alterable items are exemplified as follows, but are not limited to these.
(a1) Alteration or narrowing down of a delivery period
(a2) Alteration or narrowing down of a delivery area (region→country→port, or the like)
(a3) Alteration or narrowing down of a delivery quantity of merchandise
(a4) Alteration of quality of merchandise
(a5) Alteration of the number of cargoes

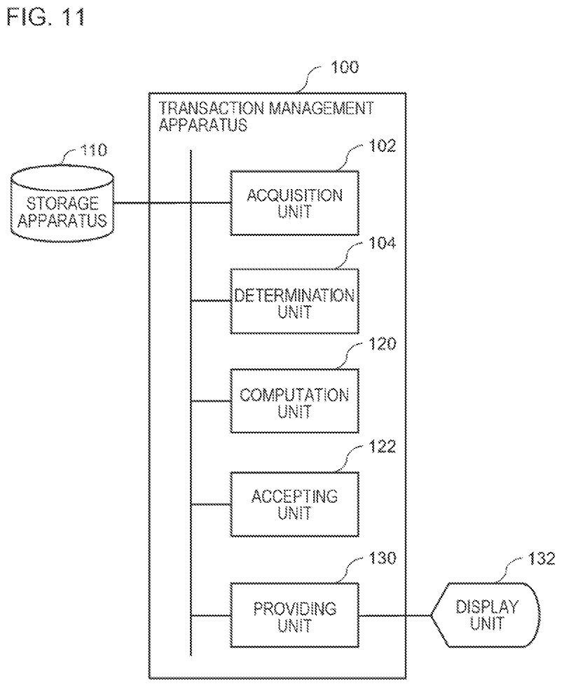

Further, as illustrated in FIG. 11, the transaction management apparatus 100 may include a providing unit 130, in addition to a configuration of the transaction management apparatus 100 in FIG. 9. The providing unit 130 may provide at least either one of a total transaction profit 60 before alteration, a total transaction profit 60 after alteration, and a change amount before and after alteration that have been computed.

Further, the providing unit 130 may provide, on a same screen, a total transaction profit 60 before alteration, and a total transaction profit 60 after alteration.

Further, the determination unit 104 alters a determined transaction content, in other words, a result of first time optimization within a predetermined range of limit by using the altered transaction condition. It is possible to perform simulation of relaxation, after specifying whether the altered transaction condition is applicable for each transaction. This is because there is a limit regarding the number of times (e.g., ten transactions out of one hundred transactions in total) by which negotiation for relaxing a transaction condition can be performed. Further, this is also because there is no room for negotiation depending on a transaction party, there is an item of a transaction condition in which negotiation for relaxation cannot be performed, or the like.

Specifically, information indicating a transaction content of each transaction further has a fixed flag. For example, a fixed flag is set to “1” in a transaction in which an alteration is possible, and a fixed flag is set to “0” in a transaction in which an alteration is not possible. A fixed flag is provided in a fixed column 322 of a last row in the matching details 320 in FIG. 8.

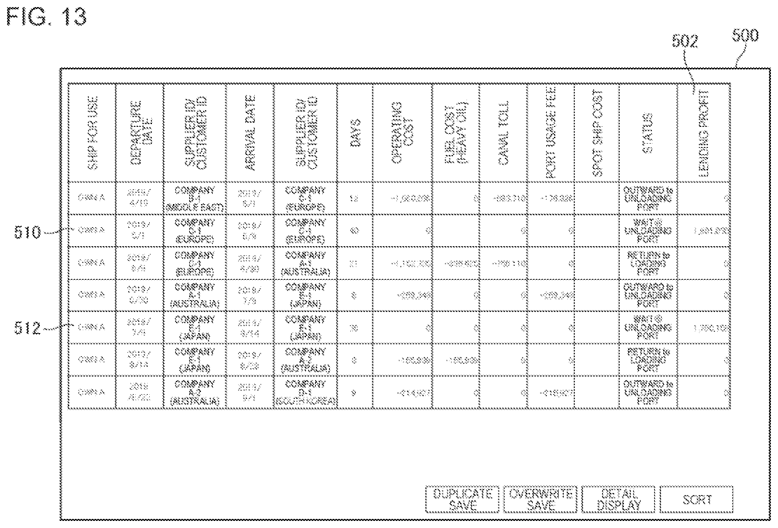

The fixed flag “1” or “0” is one example, and the fixed flag is not limited to the above. For example, a plurality of patterns may be set, and the determination unit 104 may output a plurality of simulation results by performing optimization processing for each pattern. Further, it is also possible to fix for each item of a transaction content. For example, a ship for use, a delivery date, or sublease of a ship (lending of an own ship), or the like may be set as fixed. In this case, a plurality of fixed flags may be prepared, and each of the fixed flags may be set. For example, a fixed flag indicating the matching described above may be set to “T”, a fixed flag indicating a ship for use may be set to “S”, and a fixed flag indicating a delivery date may be set to “D”, and the like. Further, a fixed flag indicating ship sublease may be set to a flag that fixes specification that sublease is not permitted for each ship. A flag may be specified by an operator by providing, for each ship, an unillustrated sublease inhibition flag column in a list of a screen for a ship navigation route result 500 in FIG. 13 to be described later.

The screen for an optimization result 300 may include, for each transaction, a graphical user interface (GUI) for altering a fixed flag indicating whether an alteration is possible. The accepting unit 122 accepts, for each transaction, specification as to whether relaxation of a transaction condition is possible, and store the specification in association with information indicating a transaction content of each transaction.

Further, difficulty indicating whether negotiation for relaxing a transaction condition is possible may be set for each of at least either one of transaction parties being the supplier 10 and the customer 20. The supply condition 202 in FIG. 5A and the sales condition 204 in FIG. 5B may further include difficulty of negotiation of each transaction party. In a case where difficulty (e.g., level 1, 2, 3) of a transaction party satisfies a criterion (e.g., less than level 2), the accepting unit 122 accepts information indicating an alteration of a transaction condition of the transaction party.

A higher difficulty indicates that negotiation for relaxing a condition is more difficult, and difficulty of a transaction party with which negotiation is not possible is set to a highest level (e.g., level 3). It is assumed that negotiation with a transaction party is possible, in a case where difficulty of a transaction party is less than a predetermined value (level 1 and level 2). It is assumed that negotiation with a transaction party is not possible, in a case where difficulty of the transaction party is equal to or more than the predetermined value (level 3). It is determined that a transaction condition of a transaction party with which negotiation is possible can be altered, and a transaction condition of a transaction party with which negotiation is difficult cannot be altered.

In this example, difficulty is indicated by three levels, but is not limited to this. For example, difficulty may be indicated by a negotiation success rate (%) or the like of a transaction party. In a case where a negotiation success rate is higher than a predetermined value (e.g., 80% or more), it may be determined that difficulty of a transaction party satisfies a criterion, in other words, it is possible to alter a transaction condition of the transaction party. Further, difficulty may be generated by accumulating a negotiation result for each transaction party, and by machine learning.

In the configuration, the transaction management apparatus 100 may further include an alteration unit (not illustrated) that sets, to a fixed flag, “1” indicating that an alteration of a transaction content is possible, regarding a transaction related to a transaction party in which difficulty of the transaction party satisfies a criterion. The alteration unit may further set, to a fixed flag, “0” indicating that an alteration of a transaction content is not possible, regarding a transaction related to a transaction party in which difficulty of the transaction party does not satisfy a criterion (difficulty is 2 or more).

Further, difficulty may be set for each item of a transaction condition. In a case where difficulty of an item of a transaction condition satisfies a criterion, the accepting unit 122 accepts information indicating an alteration of a transaction condition of the item. It is assumed that a higher difficulty indicates that negotiation for relaxing a condition of the item is more difficult, and a transaction in which negotiation is not possible is present. In a case where difficulty of an item of a transaction condition is lower than a predetermined value, it is assumed that negotiation for relaxing an item of the transaction condition is possible. In a case where difficulty of an item of a transaction condition is equal to or more than the predetermined value, it is assumed that negotiation for relaxing an item of the transaction condition is not possible.

In the configuration, regarding a transaction in which difficulty of an item of a transaction condition satisfies a criterion, the alteration unit may set, to a fixed flag, “1” indicating that an alteration of a transaction content of the transaction is possible. Regarding a transaction in which difficulty of an item of a transaction condition does not satisfy a criterion, the alteration unit may further set, to a fixed flag, “0” indicating that an alteration of a transaction content of the transaction is possible.

### Operation Example

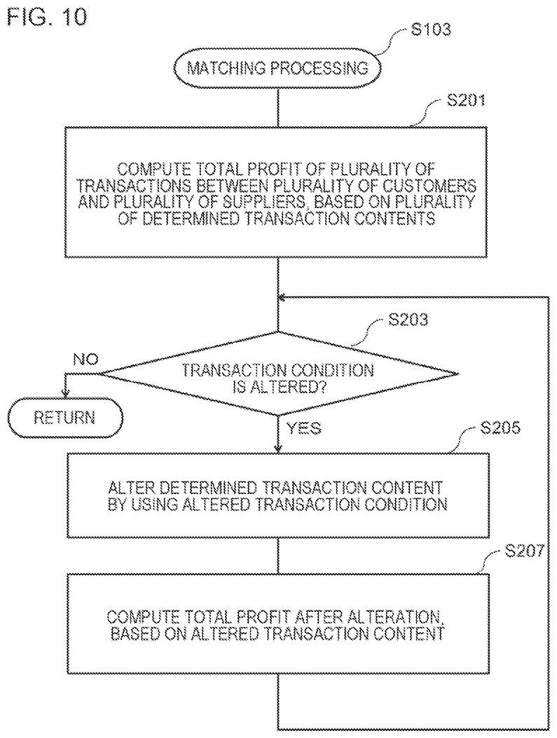

FIG. 10 is a flowchart illustrating an operation example of the transaction management apparatus 100 according to the present example embodiment. FIG. 10 illustrates a procedure of processing in which an input, by an operator, of information indicating an alteration for relaxing a transaction condition is accepted, and a total transaction profit 60 is computed according to the altered condition, within matching processing of step S103 of the flowchart in FIG. 4.

First, the computation unit 120 computes a total transaction profit 60 of a plurality of transactions between a plurality of the customers 20 and a plurality of the suppliers 10, based on a plurality of transaction contents determined by the determination unit 104 in the step S103 in FIG. 4 (step S201). Then, when accepting an alteration operation by an operator (YES in step S203), the accepting unit 122 alters a transaction content determined in the step S103 by using the altered transaction condition (step S205).

Then, the computation unit 120 computes a total transaction profit 60 after alteration of a transaction condition, in other words, after attempting relaxation of a condition according to a transaction content altered in the step S205 (step S207). Then, processing returns to the step S203. When an alteration is accepted again (YES in step S203), it is possible to repeat simulation of relaxation in the steps S205 and S207. When an alteration of a transaction condition is not accepted (NO in step S203), the processing returns to processing in FIG. 4, and the processing ends.

Note that, the flowchart describes that processing before alteration and processing after alteration are performed in order, but the example embodiment is not limited to the above. Processing before alteration and processing after alteration may be concurrently performed, or a plurality of alteration patterns may be concurrently performed.

Processing of flowcharts in FIGS. 4 and 10 may be performed one time a day, for example, and optimization may be repeated. At this occasion, a transaction in which “1” is set to a fixed flag as described above is a target for re-optimization. A transaction in which “0” is set to a fixed flag is not a target for re-optimization. In this way, since the entirety of transactions is not a target for optimization processing, it is possible to efficiently reduce load of arithmetic processing, and shorten a time required for arithmetic processing.

Further, the computation unit 120 may compute a change amount between a total transaction profit 60 before alteration and a total transaction profit 60 after alteration (not illustrated). Further, the providing unit 130 may provide at least one of a total transaction profit 60 before alteration, a total transaction profit 60 after alteration, and a change amount between the transaction total gross 60 before alteration and the transaction total gross 60 after alteration (not illustrated). Furthermore, the providing unit 130 may display, on a same screen, a total transaction profit 60 before alteration, and a total transaction profit 60 after alteration (not illustrated).

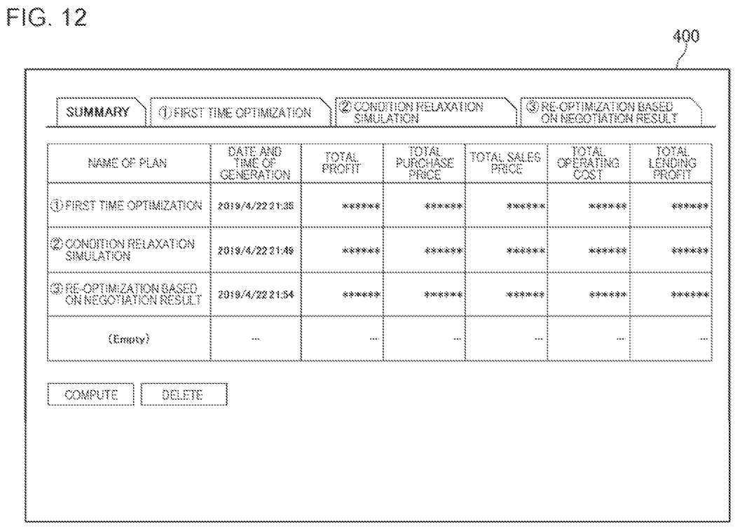

FIG. 12 is a diagram illustrating one example of a screen for a relaxation simulation result 400 according to the present example embodiment. The screen for a relaxation simulation result 400 includes, on a same screen, a first time optimization result before alteration, a simulation result in which a transaction condition is relaxed, and an optimization result based on a transaction condition being altered as a result of negotiation with a transaction party.

In the example in FIG. 12, each result includes a date and time of generation, a total profit, a total purchase price, a total sales price, a total operating cost, and a total lending profit. The example in FIG. 12 is a screen when a tab indicating an overview of a relaxation simulation result is selected. The screen for a relaxation simulation result 400 includes other tabs, specifically, each tab for displaying a first time optimization result before alteration, a simulation result in which a transaction condition is relaxed, and an optimization result based on a transaction condition being altered as a result of negotiation with a transaction party. When these tabs are selected, for example, the screen for an optimization result 300 to be generated at each timing in FIG. 8 is displayed.

In the transaction management apparatus 100 according to the present example embodiment, an input indicating an alteration of a transaction condition is accepted by the accepting unit 122, optimization processing is performed again within a range of a transaction condition altered by the determination unit 104, and the total transaction profits 60 based on a transaction content before alteration and after alteration of a transaction condition is each computed by the computation unit 120.

With this configuration, it is possible to efficiently perform simulation from a first time transaction content before negotiation for relaxing a condition, or computation of the total transaction profit 60 based on a formal transaction content after negotiation. The transaction management apparatus 100 according to the present example embodiment provides an advantageous effect similar to that of the above-described example embodiments, and can efficiently make a plan on negotiation for relaxing a condition, and reflect the plan. Further, also in a case where an alteration occurs in operation of the transport means 30 due to a weather condition or the like, it is possible to optimize again a transaction content after altering a transport condition 206 of the transport means 30 thus, it is possible to flexibly cope with an unexpected alteration.

### Fourth Example Embodiment

A transaction management apparatus 100 according to the present example embodiment is similar to that of one of the above-described example embodiments except for a point that the transaction management apparatus 100 has a configuration in which a case of lending a transport means 30 owned or contracted by an own company to a third party is considered. The transaction management apparatus 100 according to the present example embodiment can be combined with one of the above-described example embodiments. Herein, description is made based on a premise that the transaction management apparatus 100 according to the present example embodiment has a same configuration as that of the transaction management apparatus 100 according to the third example embodiment in FIG. 11.

A determination unit 104 preferentially allocates, as the transport means 30, an own ship of no cost. Then, in a case where an own ship is not available, the determination unit 104 performs matching in such a way that a spot ship is used. However, in a case where using a spot ship makes a profit, the example embodiment is not limited to the above. For example, since a spot ship can be abandoned after unloading, it is possible to reduce a cost by a cost for return navigation.

On the other hand, in a case where a period of time when an own ship is not used is present, profit loss may occur by a maintenance cost. In view of the above, in the present example embodiment, the determination unit 104 also takes into consideration, as a matching condition, lending an own ship to a third party, and gaining a lending profit.

The determination unit 104 optimizes and determines a transaction content in such a way that a total transaction profit 60 increases, when it is assumed that an own company lends the owned (contracted) transport means 30 to a third party.

For example, in a case where waiting days of an own ship exceed a fixed period of time (e.g., 30 days), and in a case where a profit increases by lending (sublease) of the own ship, the determination unit 104 includes, in a condition of a transport condition 206, sublease of the own ship as a target for optimization.

The transport condition 206 includes a condition related to the transport means 30 (own ship) owned by an own company, and a condition when the transport means 30 is contracted each time with another company (use of a spot ship). The supply condition 202 and the sales condition 204 described in the above-described example embodiments may also be set for each type of a contract, such as a long-term contract, a spot contract (case of using a spot ship or the like), a portfolio contract, and a term contract.

A storage apparatus 110 stores, as ship information of the transport means 30, for example, information such as a ship name (including identification information), discrimination between an own ship and a spot ship, a loadable capacity, and fuel consumption for each velocity. Further, the storage apparatus 110 stores, as port information, information such as a travel distance between ports, a canal used for each sea route, a usage fee, and a ship being prohibited from entering a port. Further, the storage apparatus 110 stores information such as price transition for each price index.

Ship-related costs include the following contents, but are not limited to these.
(b1) Charter fee of spot ship: computed by a charter fee per day (tariff for each season)×navigation days
(b2) Fixed charter fee of spot ship: total of average costs such as travel expenses to a loading location, and travel expenses to a returning location
(b3) Fuel cost: computed based on fuel consumption for each navigation velocity
(b4) Port usage fee: computed based on a tariff for each port, for each ship category
(b5) Canal toll: computed based on a toll tariff at the Panama Canal or the Suez Canal

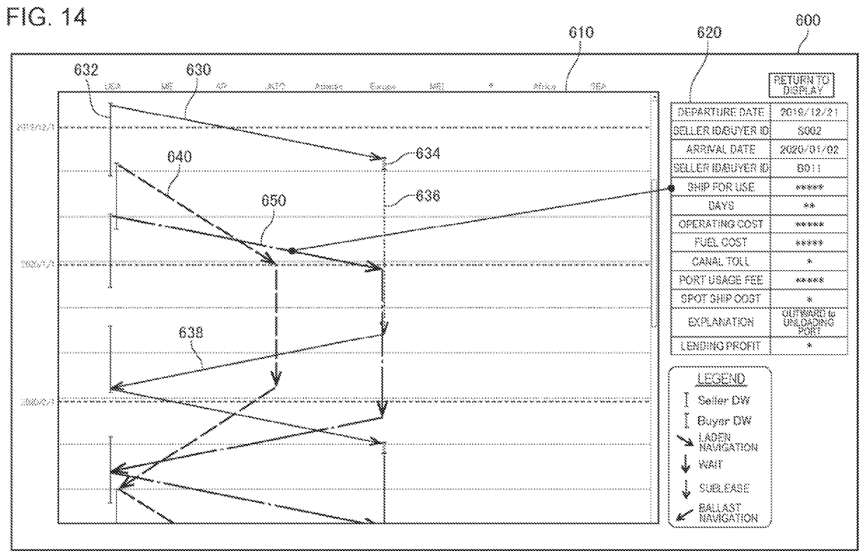

FIG. 13 is a diagram illustrating one example of a screen for a ship navigation route result 500. FIG. 14 is a diagram illustrating one example of a screen for a ship schedule 600.

A providing unit 130 provides the screen for a ship navigation route result 500 and the screen for a ship schedule 600. The screen for a ship navigation route result 500 in FIG. 13 includes an optimization result of the transport means 30 determined by the determination unit 104. The screen for a ship navigation route result 500 includes a lending profit column 502 indicating a lending profit when an own ship is lent. For example, a record 510 and a record 512 indicate that an own ship is subleased. Therefore, a lending profit is generated.

The screen for a ship schedule 600 in FIG. 14 indicates optimized schedules of a plurality of ships as a chart 610. In FIG. 14, a different ship schedule is indicated by a different line type (e.g., a solid line 630, a dashed line 640, a one-dotted chain line 650, and the like). Alternatively, different ship schedules may be indicated by different colors.

A ship departs from the U.S.A. in late November, 2019, makes a loading navigation (laden navigation) indicated by the solid line 630, and arrives at Europe in early December, 2019. A zone indicated by a reference sign 632 indicates a delivery window (DW) during which delivery is possible for a supplier 10. A zone indicated by a reference sign 634 indicates DW during which delivery is possible for a customer 20. The DW of the supplier 10 and the DW of the customer 20 are indicated by different line types or lines of different colors.

Then, after arrival at Europe, the ship indicated by the solid line 630 is lent to another company until middle January, 2020. A period of time of sublease of the ship is indicated by a dotted line 636 on the chart 610.

Then, the ship departs from Europe in middle January, 2020, makes an empty navigation (ballast navigation) indicated by a solid line 638, and arrives at the U.S.A. in late January, 2020.

Further, when a selection operation (touch or click) by an operator is accepted on a line of each ship, a window 620 indicating a detailed content of the navigation may be displayed. FIG. 14 illustrates the window 620 displayed when the one-dotted chain line 650 is operated to be selected.

In the present example embodiment, a transaction content is optimized by the determination unit 104 in such a way that the total transaction profit 60 increases, when it determines that an own ship is lent to a third party. Therefore, the transaction management apparatus 100 according to the present example embodiment provides a similar advantageous effect to that of the above-described example embodiments, and can optimize a transaction content including sublease of an own ship in a plan, in a case where sublease of the own ship increases a profit. Further, a trader can determine whether sublease of an own ship is performed by watching a profit being computed by a computation unit 120 and provided by the providing unit 130.

In the foregoing, example embodiments according to the present invention have been described with reference to the drawings, however, these example embodiments are examples according to the present invention, and various configurations other than the above can also be adopted.

For example, in another example embodiment, an accepting unit 122 may accept specification of a limit time of optimization processing. Further, by changing a gap of a result of optimization processing, a time required for arithmetic processing may be changed. A computation unit 120 may repeat optimization processing in such a way that a gap difference gradually decreases, and terminate the optimization processing at a point of time when the time exceeds a limit time.

While the invention of the present application has been described with reference to the example embodiments and examples, the invention of the present application is not limited to the above-described example embodiments and examples. A configuration and details of the invention of the present application may be modified in various ways comprehensible to a person skilled in the art within the scope of the invention of the present application.

Note that, in a case where information related to a user or a contract is acquired and used in the present invention, the acquisition and the usage are assumed to be performed legally.

A part or all of the above-described example embodiment may also be described as the following supplementary notes, but is not limited to the following.

1. A transaction management apparatus including:

an acquisition unit that acquires, for a same piece of merchandise, a supply condition of each of a plurality of suppliers, a sales condition of each of a plurality of customers, and a transport condition of each of a plurality of transport means; and

a determination unit that optimizes and determines, for the each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

2. The transaction management apparatus according to supplementary note 1, further including:

a computation unit that computes, based on a plurality of the transaction contents determined by the determination unit, the total profit of a plurality of the transactions between a plurality of the customers and a plurality of the suppliers; and

an accepting unit that accepts an input by an operator indicating an alteration of a transaction condition for relaxing the transaction condition being at least one of the sales condition and the supply condition, wherein,

when the alteration of the transaction condition is accepted by the accepting unit, the determination unit alters the determined transaction content by using the altered transaction condition, and

the computation unit further computes the total profit after alteration, based on the altered transaction content.

3. The transaction management apparatus according to supplementary note 2, further including

a providing unit that provides, on a same screen, the total profit before the alteration, and the total profit after the alteration.

4. The transaction management apparatus according to supplementary note 3, wherein

the determination unit alters the determined transaction content within a predetermined range of limit by using the altered transaction condition.

5. The transaction management apparatus according to supplementary note 4, wherein

difficulty indicating whether negotiation for relaxing the transaction condition is possible is set for each transaction party being at least one of the customer and the supplier, and

the accepting unit accepts information indicating the alteration of the transaction condition of the transaction party, when the difficulty of the transaction party satisfies a criterion.

6. The transaction management apparatus according to supplementary note 5, wherein

the difficulty is further set for each item of the transaction condition, and

the accepting unit accepts information indicating the alteration of the transaction condition of the item, when the difficulty of the item of the transaction condition satisfies a criterion.

7. The transaction management apparatus according to any one of supplementary notes 1 to 6, wherein

the determination unit determines the supply quantity of the supplier in such a way that a profit margin between a price for the customer and a price for the supplier increases for the each transaction.

8. The transaction management apparatus according to supplementary note 7, wherein

the determination unit maximizes the supply quantity, when the profit margin is a plus margin, and minimizes the supply quantity, when the profit margin is a minus margin.

9. The transaction management apparatus according to any one of supplementary notes 1 to 8, wherein

the determination unit optimizes and determines the transaction content in such a way that the total profit increases, when it is assumed that the transport means owned by an own company is lent to a third party.

10. The transaction management apparatus according to any one of supplementary notes 1 to 9, wherein

the transport condition includes a condition related to the transport means owned by an own company, and a condition when the transport means is contracted each time with another company.

11. A transaction management method including:

by a transaction management apparatus,

acquiring, for a same piece of merchandise, a supply condition of each of a plurality of suppliers, a sales condition of each of a plurality of customers, and a transport condition of each of a plurality of transport means; and

optimizing and determining, for the each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

12. The transaction management method according to supplementary note 11, further including:

by the transaction management apparatus,

computing, based on a plurality of the determined transaction contents, the total profit of a plurality of the transactions between a plurality of the customers and a plurality of the suppliers;

accepting an input by an operator indicating an alteration of a transaction condition for relaxing the transaction condition being at least one of the sales condition and the supply condition;

altering the determined transaction content by using the altered transaction condition, when the alteration of the transaction condition is accepted; and

further computing the total profit after alteration, based on the altered transaction content.

13. The transaction management method according to supplementary note 12, further including,

by the transaction management apparatus,

providing, on a same screen, the total profit before the alteration, and the total profit after the alteration.

14. The transaction management method according to supplementary note 13, further including,

by the transaction management apparatus,

altering the determined transaction content within a predetermined range of limit by using the altered transaction condition.

15. The transaction management method according to supplementary note 14, wherein

difficulty indicating whether negotiation for relaxing the transaction condition is possible is set for each transaction party being at least one of the customer and the supplier,

the transaction management method further including,

by the transaction management apparatus,

accepting information indicating the alteration of the transaction condition of the transaction party, when the difficulty of the transaction party satisfies a criterion.

16. The transaction management method according to supplementary note 15, wherein

the difficulty is further set for each item of the transaction condition,

the transaction management method further including,

by the transaction management apparatus,

accepting information indicating the alteration of the transaction condition of the item, when the difficulty of the item of the transaction condition satisfies a criterion.

17. The transaction management method according to any one of supplementary notes 11 to 16, further including,

by the transaction management apparatus,

determining the supply quantity of the supplier in such a way that a profit margin between a price for the customer and a price for the supplier increases for the each transaction.

18. The transaction management method according to supplementary note 17, further including,

by the transaction management apparatus,

maximizing the supply quantity, when the profit margin is a plus margin, and minimizing the supply quantity, when the profit margin is a minus margin.

19. The transaction management method according to any one of supplementary notes 11 to 18, further including,

by the transaction management apparatus,

optimizing and determining the transaction content in such a way that the total profit increases, when it is assumed that the transport means owned by an own company is lent to a third party.

20. The transaction management method according to any one of supplementary notes 11 to 19, wherein

the transport condition includes a condition related to the transport means owned by an own company, and a condition when the transport means is contracted each time with another company.

21. A program causing a computer to execute:

a procedure of acquiring, for a same piece of merchandise, a supply condition of each of a plurality of suppliers, a sales condition of each of a plurality of customers, and a transport condition of each of a plurality of transport means; and

a procedure of optimizing and determining, for the each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

22. The program according to supplementary note 21, further causing the computer to execute:

a procedure of computing, based on a plurality of the determined transaction contents, the total profit of a plurality of the transactions between a plurality of the customers and a plurality of the suppliers;

a procedure of accepting an input by an operator indicating an alteration of a transaction condition for relaxing the transaction condition being at least one of the sales condition and the supply condition;

a procedure of altering the determined transaction content by using the altered transaction condition, when the alteration of the transaction condition is accepted; and

a procedure of further computing the total profit after alteration, based on the altered transaction content.

23. The program according to supplementary note 22, further causing the computer to execute

a procedure of providing, on a same screen, the total profit before the alteration, and the total profit after the alteration.

24. The program according to supplementary note 23, further causing the computer to execute

a procedure of altering the determined transaction content within a predetermined range of limit by using the altered transaction condition.

25. The program according to supplementary note 24, wherein

difficulty indicating whether negotiation for relaxing the transaction condition is possible is set for each transaction party being at least one of the customer and the supplier,

the program further causing the computer to execute

a procedure of accepting information indicating the alteration of the transaction condition of the transaction party, when the difficulty of the transaction party satisfies a criterion.

26. The program according to supplementary note 25, wherein

the difficulty is further set for each item of the transaction condition,

the program further causing the computer to execute

a procedure of accepting information indicating the alteration of the transaction condition of the item, when the difficulty of the item of the transaction condition satisfies a criterion.

27. The program according to any one of supplementary notes 21 to 26, further causing the computer to execute

a procedure of determining the supply quantity of the supplier in such a way that a profit margin between a price for the customer and a price for the supplier increases for the each transaction.

28. The program according to supplementary note 27, further causing the computer to execute

a procedure of maximizing the supply quantity, when the profit margin is a plus margin, and minimizing the supply quantity, when the profit margin is a minus margin.

29. The program according to any one of supplementary notes 21 to 28, further causing the computer to execute

a procedure of optimizing and determining the transaction content in such a way that the total profit increases, when it is assumed that the transport means owned by an own company is lent to a third party.

30. The program according to any one of supplementary notes 21 to 29, wherein

the transport condition includes a condition related to the transport means owned by an own company, and a condition when the transport means is contracted each time with another company.

This application is based upon and claims the benefit of priority from Japanese patent application No. 2019-207688, filed on Nov. 18, 2019, the disclosure of which is incorporated herein in its entirety by reference.

### Reference Signs List

10 Supplier
20 Customer
30 Transport means
50 Matching result
60 Total transaction profit
100 Transaction management apparatus
102 Acquisition unit
104 Determination unit
110 Storage apparatus
120 Computation unit
122 Accepting unit
130 Providing unit
132 Display unit
202 Supply condition
204 Sales condition
206 Transport condition
212 Long-term contract basic information
214 Long-term contract cargo individual information
216 Spot transaction information
218 Market transaction prospect information
222 Own ship specification information
224 Spot ship specification information
230 Travel distance information
232 Port information
234 Port entry availability information
236 Canal toll information
238 Canal use navigation information
240 Price index information
300 Screen for an optimization result
310 Contract information
320 Matching details
322 Fixed column
400 Screen for a relaxation simulation result
500 Screen for a ship navigation route result
502 Lending profit column
600 Screen for a ship schedule
610 Chart
620 Window
1000 Computer
1010 Bus
1020 Processor
1030 Memory
1040 Storage device
1050 Input/output interface
1060 Network interface

What is claimed is:

1. A transaction management apparatus comprising:
a memory configured to store instructions; and
a processor configured to execute the instructions to:
acquire, for a same piece of merchandise, a supply condition of each of a plurality of suppliers, a sales condition of each of a plurality of customers, and a transport condition of each of a plurality of transport means; and
optimize and determine, for each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

2. The transaction management apparatus according to claim 1, wherein the processor is further configured to execute the instructions to:
compute, based on a plurality of the determined transaction contents, the total profit of a plurality of the transactions between a plurality of the customers and a plurality of the suppliers;
accept an input by an operator indicating an alteration of a transaction condition for relaxing the transaction condition being at least one of the sales condition and the supply condition;
when the alteration of the transaction condition is accepted, alter the determined transaction content by using the altered transaction condition; and
further compute the total profit after alteration, based on the altered transaction content.

3. The transaction management apparatus according to claim 2, wherein the processor is further configured to execute the instructions to
provide, on a same screen, the total profit before the alteration, and the total profit after the alteration.

4. The transaction management apparatus according to claim 3, wherein the processor is further configured to execute the instructions to
alter the determined transaction content within a predetermined range of limit by using the altered transaction condition.

5. The transaction management apparatus according to claim 4, wherein
difficulty indicating whether negotiation for relaxing the transaction condition is possible is set for each transaction party being at least one of the customer and the supplier, and
the processor is further configured to execute the instructions to
accepts accept information indicating the alteration of the transaction condition of the transaction party, when the difficulty of the transaction party satisfies a criterion.

6. The transaction management apparatus according to claim 5, wherein
the difficulty is further set for each item of the transaction condition, and
the processor is further configured to execute the instructions to
accept information indicating the alteration of the transaction condition of the item, when the difficulty of the item of the transaction condition satisfies a criterion.

7. The transaction management apparatus according to claim 1, wherein the processor is further configured to execute the instructions to
determine the supply quantity of the supplier in such a way that a profit margin between a price for the customer and a price for the supplier increases for the each transaction.

8. The transaction management apparatus according to claim 7, wherein the processor is further configured to execute the instructions to
maximize the supply quantity, when the profit margin is a plus margin, and minimizes the supply quantity, when the profit margin is a minus margin.

9. The transaction management apparatus according to claim 1, wherein the processor is further configured to execute the instructions to
optimize and determines the transaction content in such a way that the total profit increases, when it is assumed that the transport means owned by an own company is lent to a third party.

10. The transaction management apparatus according to claim 1, wherein
the transport condition includes a condition related to the transport means owned by an own company, and a condition when the transport means is contracted each time with another company.

11. A transaction management method comprising:
by a transaction management apparatus,
acquiring, for a same piece of merchandise, a supply condition of each of a plurality of suppliers, a sales condition of each of a plurality of customers, and a transport condition of each of a plurality of transport means; and
optimizing and determining, for each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

12. The transaction management method according to claim 11, further comprising:
by the transaction management apparatus,
computing, based on a plurality of the determined transaction contents, the total profit of a plurality of the transactions between a plurality of the customers and a plurality of the suppliers;
accepting an input by an operator indicating an alteration of a transaction condition for relaxing the transaction condition being at least one of the sales condition and the supply condition;
altering the determined transaction content by using the altered transaction condition, when the alteration of the transaction condition is accepted; and
further computing the total profit after alteration, based on the altered transaction content.

13. The transaction management method according to claim 12, further comprising,
by the transaction management apparatus,
providing, on a same screen, the total profit before the alteration, and the total profit after the alteration.

14. The transaction management method according to claim 13, further comprising,
by the transaction management apparatus,
altering the determined transaction content within a predetermined range of limit by using the altered transaction condition.

15. The transaction management method according to claim 14, wherein
difficulty indicating whether negotiation for relaxing the transaction condition is possible is set for each transaction party being at least one of the customer and the supplier,
the transaction management method further comprising,
by the transaction management apparatus,
accepting information indicating the alteration of the transaction condition of the transaction party, when the difficulty of the transaction party satisfies a criterion.

16. The transaction management method according to claim 15, wherein
the difficulty is further set for each item of the transaction condition,
the transaction management method further comprising,
by the transaction management apparatus,
accepting information indicating the alteration of the transaction condition of the item, when the difficulty of the item of the transaction condition satisfies a criterion.

17. The transaction management method according to claim 11, further comprising,
by the transaction management apparatus,
determining the supply quantity of the supplier in such a way that a profit margin between a price for the customer and a price for the supplier increases for the each transaction.

18. The transaction management method according to claim 17, further comprising,
by the transaction management apparatus,
maximizing the supply quantity, when the profit margin is a plus margin, and minimizing the supply quantity, when the profit margin is a minus margin.

19. The transaction management method according to claim 11, further comprising,
by the transaction management apparatus,
optimizing and determining the transaction content in such a way that the total profit increases, when it is assumed that the transport means owned by an own company is lent to a third party.

20. (canceled)

21. A non-transitory computer-readable storage medium storing a program causing a computer to execute:
a procedure of acquiring, for a same piece of merchandise, a supply condition of each of a plurality of suppliers, a sales condition of each of a plurality of customers, and a transport condition of each of a plurality of transport means; and
a procedure of optimizing and determining, for the each transaction, a transaction content including a supply quantity of the supplier, a loading quantity of the transport means for each loading location, and an unloading quantity of the transport means for each unloading location in such a way that a total profit from a plurality of transactions of the merchandise between a plurality of the suppliers and a plurality of the customers increases by using a plurality of the acquired supply conditions, a plurality of the acquired sales conditions, and a plurality of the acquired transport conditions.

22. (canceled)
